(19) United States
(12) Patent Application Publication
(10) Pub. No.: US 2023/0081285 A1
(43) Pub. Date: Mar. 16, 2023

(54) PREPARATION COMPRISING A HYDRAULIC BINDING AGENT AND A CELLULOSE ETHER

(71) Applicant: SE TYLOSE GMBH & CO. KG, Wiesbaden (DE)

(72) Inventors: Vanessa HAVENITH, Wiesbaden (DE); Heiko NEBEL, Wiesbaden (DE)

(21) Appl. No.: 17/794,490

(22) PCT Filed: Jan. 20, 2021
(86) PCT No.: PCT/EP2021/051141

§ 371 Date: Jul. 21, 2022

(30) Foreign Application Priority Data
Jan. 21, 2020 (EP) 20152829.6

(51) Int. Cl. C04B 24/38; C04B 28/02; C04B 14/28; C04B 14/06

(52) U.S. Cl. CPC C04B 24/383; C04B 28/02; C04B 14/28; C04B 14/06; C04B 2111/00637

(57) ABSTRACT

The invention relates to a preparation comprising at least one hydraulic binding agent and at least one cellulose ether selected from methylhydroxyethylhydroxypropylcellulose (MHEHPC) and the use thereof, in particular in building material systems.

The present invention relates to a preparation comprising at least one hydraulic binding agent and at least one cellulose ether selected from methylhydroxyethylhydroxypropylcellulose (MHEHPC), and to the use thereof, in particular in building materials containing hydraulic binding agents.

In the construction industry, cementitious adhesives, plasters, fillers and special adhesive and reinforcing fillers for composite thermal insulation systems, among others, are used for bonding or coating of building components. These are mixtures of one or more binding agents (e.g. cement, hydraulic lime), fillers (e.g. sands with various grain sizes) and other additives, such as cellulose ethers, dispersion powders, starch, starch derivatives, such as starch ethers, and air entraining agents. These building materials are called industrial ready mix dry mortars because they are produced in the factory and only need to be mixed with water for processing.

The main property of cellulose ethers in these building materials is its water retention effect to ensure longer processability as well as uniform drying. This characteristic is particularly substantial in thin-bed mortars, such as tile adhesives, fillers or thin-wall plasters. Furthermore, cellulose ethers in the form of methylhydroxyethylcellulose (MHEC) or methylhydroxypropylcellulose (MHPC) have the characteristic of introducing air voids into building materials, which is caused by the reduction of surface activity in combination with water. The introduction of air voids allows easier processing of mortars. The more air voids are entrained there is in the building material system, the creamier the building material becomes and the easier its processing, which makes work easier for the user. However, too much air has the disadvantage that the strength of set mortars can be drastically reduced in some cases. It is also difficult to achieve a stable air entrainment in the building material so that easy and simple processing can be maintained in the long term. If a stable and at the same time high air entrainment can be achieved, possible areas of application would also be in thermal insulation or soundproofing.

Conventional binary cellulose ethers such as MHEC or MHPC already ensure stable air entrainment and thus good processing, but the air entrainment is not so high as to result in extreme ease of work.

Surprisingly, however, the use of the ternary mixed ether MHEHPC in building materials containing hydraulic binding agents showed a very stable and high air entrainment, which is accompanied by a reduction in the bulk density of the building material containing hydraulic binding agents. This has a particularly positive effect on the processing properties of the building material containing hydraulic binding agents, without causing any loss of strength in the set mortar. In the prior art, building material additives for reducing the bulk density are usually accompanied by a reduction in the strength of the set mortar. In this context, mortar refers to the building material containing hydraulic binding agents to which water has been added.

Another advantage of MHEHPC is its lower impact on the hydration of hydraulic binding agents. Hydration of hydraulic binding agents describes the hardening of the building material containing hydraulic binding agents during the reaction between the main components of the building material and the addition water to form hydrate phases. All cellulose ethers delay hydration depending on the level of etherification.

EP 2 058 336 A1 describes MHEHPC having a specific substitution pattern, its preparation as well as its use in dispersion-bound building material systems, in particular in dispersion-bound paints. The described MHEHPC shows a low surface swelling in aqueous dispersion, a high high-shear viscosity as aqueous solution as well as a thermal flocculation point of at least 65° C. in water and is therefore used as thickener in dispersion paints.

The subject-matter of DE 10 2007 016 726 A1 as well as of WO 2008/122344 A1 is the production of MHEHPC as well as its use in gypsum-bonded building material systems. MHEHPC reduces agglomeration in these building material systems and thus improves their processability.

Other patents such as U.S. Pat. No. 3,873,518 or DE 24 57 181 describe the production of MHEHPC with a specific substitution pattern and its use in dispersion-bound paints. The cellulose derivatives are characterized by an excellent color tolerability and enzyme resistance.

EP 0 269 015 A2 describes dry set mortar compositions having improved stability, which is achieved by the use of a combination of finely divided silica and water retentive agents, such as cellulose ethers. In particular, methyl cellulose, MHPC and MHEC are used.

EP 0 554 751 A1 describes water-soluble, ionic, sulfoalkyl-modified cellulose derivatives and their use as additives for gypsum- and cement-based building material systems. An improved water retention value of the sulfoalkyl-modified cellulose derivatives compared to conventional cellulose derivatives is discussed.

Thus, there is no information in the prior art regarding the positive properties caused by MHEHPC in building materials containing hydraulic binding agents.

The problem underlying the present invention is providing an additive for building materials containing hydraulic binding agents that promotes processability without causing losses in durability of the cured building material.

This problem was solved by a preparation comprising
(i) at least one hydraulic binding agent,
(ii) at least one cellulose ether selected from methylhydroxyethylhydroxypropylcellulose (MHEHPC),
(iii) optionally at least one filler,
(iv) optionally at least one additive, and
(v) optionally water.

A hydraulic binding agent is preferably an inorganic, non-metallic substance which, after mixing with water, hardens independently as a result of chemical reactions with the mixing water and, after hardening, remains solid and maintains soundness even in case of contact with water.

Component (i) of the preparation according to the present invention is preferably selected from cement and hydraulic lime, in particular cement.

The preparation according to the present invention preferably comprises
(i) at least one cement,
(ii) at least one cellulose ether selected from methylhydroxyethylhydroxypropylcellulose (MHEHPC),
(iii) optionally at least one filler,
(iv) optionally at least one additive, and
(v) optionally water.

Preferably, the at least one cement is selected from the group consisting of CEM I, CEM II/A-S, CEM II/B-S, CEM II/A-D, CEM II/A-P, CEM II/B-P, CEM II/A-Q, CEM II/B-Q, CEM II/A-V, CEM II/B-V, CEM II/A-W, CEM II/B-W, CEM II/A-T, CEM II/B-T, CEM II/A-L, CEM II/B-L, CEM II/A-LL, CEM II/B-LL, CEM II/A-M, CEM II/B-M, CEM III/A, CEM III/B, CEM III/C, CEM IV/A, CEM IV/B, CEM V/A and/or CEM V/B. According to DIN EN 197-1, CEM I is Portland cement, CEM II/A-S and CEM II/B-S belong to Portland slag cement, CEM II/A-D is Portland silica fume cement, CEM II/A-P, CEM II/B-P, CEM II/A-Q and CEM II/B-Q belong to Portland pozzolanic cement, CEM II/A-V, CEM II/B-V, CEM II/A-W and CEM II/B-W belong to Portland fly ash cement, CEM II/A-T and CEM II/B-T for Portland shale cement, CEM II/A-L, CEM II/B-L, CEM II/A-LL and CEM II/B-LL for Portland stone cement, CEM II/A-M and CEM II/B-M for Portland composite cement, CEM III/A, CEM III/B and CEM III/C for blast furnace slag cement, CEM IV/A and CEM IV/B for pozzolanic cement, and CEM V/A and CEM V/B for composite cement. Preferably, the cement has a strength class according to DIN EN 197-1 of 32.5, 42.5 or 52.5. Preferably, the cement has an initial strength according to DIN EN 197-1 of N, R or L. An initial strength N describes a usual initial strength, R a high initial strength and L a low initial strength. While the strength class indicates the strength after 28 days, the initial strength provides a supplementary classification describing the strength in the early phase of setting after 2 and 7 days, respectively. Cements with lower heat of hydration may additionally be assigned the designation LH, while cements with high sulfate resistance may be assigned the designation SR.

In a further embodiment, the hydraulic lime preferably comprises CaO. Hydraulic lime is described in DIN EN 459-1 and hardens in the presence of water by hydrate formation.

Preferably, the proportion of component (i) is 10-80% by weight, based on the total mass of components (i), (ii), optionally (iii) and optionally (iv).

In a preferred embodiment, the at least one cellulose ether selected from methylhydroxyethylhydroxypropylcellulose (MHEHPC) has an average DS_{Methyl} degree of substitution of 1.2-2.35, preferably 1.5-2.25, particularly preferably 1.7-2.15, and most preferably 1.75-2.0. Preferably, the DS_{Methyl} is chosen such that the cellulose derivative is water soluble at 20° C. Preferably, MHEHPC has a water solubility of at least 2 g/L water at 20° C.

Preferably, the at least one cellulose ether selected from methylhydroxyethylhydroxypropylcellulose (MHEHPC) has a molecular degree of substitution MS_{Hydroxyethyl} of 0.1 to 0.99, preferably 0.15 to 0.8, particularly preferably 0.25-0.6, most preferably 0.2-0.5.

Preferably, the at least one cellulose ether selected from methylhydroxyethylhydroxypropylcellulose (MHEHPC) has a molecular degree of substitution MS_{Hydroxypropyl} of 0.1 to 0.99, preferably 0.15 to 0.8, particularly preferably 0.25-0.6, most preferably 0.3-0.5.

Particularly preferred is the at least one cellulose ether selected from methylhydroxyethylhydroxypropylcellulose (MHEHPC) having an average degree of substitution DS_{Methyl} of 1.2-2.35, preferably 1.5-2.25, particularly preferably 1.7-2.15, most preferably 1.75-2.0, has a molecular degree of substitution MS_{Hydroxyethyl} of 0.1 to 0.99, preferably 0.15 to 0.8, particularly preferably 0.25-0.6, most preferably 0.2-0.5, and a molecular degree of substitution MS_{Hydroxypropyl} of 0.1 to 0.99, preferably 0.15 to 0.8, particularly preferably 0.25-0.6, most preferably 0.3-0.5.

Preferably, the total molecular degree of substitution MS_{Hydroxyethyl-hydroxypropyl} is 1.1, preferably 0.9, particularly preferably 0.75, most preferably 0.6.

The average degree of substitution DS as well as the molecular degree of substitution MS are determined by the Zeisel method which is known to the person skilled in the art (literature: G. Bartelmus and R. Ketterer, Z. Anal. Chem. 286 (1977) 161-190).

In a preferred embodiment, the weight average degree of polymerization DPw of the MHEHPC is from 1 to 6000, preferably from 1 to 5000. The weight average degree of polymerization is measured by pulps according to ISO 5351:2010—“Determination of Limiting Viscosity Number in Cupriethylenediamine (CED) Solution”.

Preferred viscosity of the MHEHPC is 1 to 70,000 mPa·s, preferably 100 to 15,000 mPa·s, more preferably 1000 to 12,000 mPa·s. The viscosity measurement is carried out according to DIN 53015:2019-06—“Viscometry—Measurement of viscosity using the Hoeppler falling-ball viscometer”. The measurement is carried out in aqueous solutions of MHEHPC with 1.9% by weight of component (ii) based on the total weight of the solution at 20° C. and 20° dH.

In one embodiment, the proportion of component (ii) is preferably 0.05-0.6% by weight, preferably 0.1-0.5% by weight, most preferably 0.3-0.4% by weight based on the total weight of components (i) and (ii).

The preparation may further comprise at least one filler as component (iii), wherein the filler is preferably selected from gravel, quartz sand, limestone powder, lightweight aggregates and/or synthetic fillers.

The filler preferably has an average particle size d₅₀ of 0-3 mm, preferably 0-0.7 mm. The d₅₀ value can be determined by methods known to the person skilled in the art, e.g. laser diffraction, sieving, etc. In laser granulometry, for example, the filler is dispersed in a liquid or gaseous medium. The particle size distribution is then determined on the basis of the diffraction of a laser beam directed onto the sample medium. The d₅₀ value means that 50% of the particles are smaller than the specified value.

Preferably, the proportion of component (iii) is 5-85% by weight, particularly preferably 35-70% by weight based on the total weight of components (i), (ii), (iii) and optionally (iv).

The preparation may further comprise at least one additive as component (iv). In one embodiment, the additive may preferably be a dispersion powder, an inorganic thickener, a hardening accelerator, a setting retarder, a polymer, a defoaming agent, an air entraining agent, a flow agent, a hydrophobizing agent, and/or fibers. Preferably, the additive is a dispersion powder. Preferably, the proportion of component (iv) is 0-12% by weight, particularly preferably 1-5% by weight, based on the total mass of components (i), (ii), (iv) and optionally (iii).

The preparation may contain water as component (v). In a preferred embodiment, the proportion of component (v) is 18-32% by weight, preferably 22-28% by weight, based on the total mass of components (i) and (v). Preparations according to the present invention comprising components (i) to (iv) can harden by adding water as component (v) in a hydration reaction. The at least one hydraulic binding agent may react with water to form insoluble, stable compounds. The compounds may form crystals that interlock with each other, resulting in the high strength of the cured building material system. These compounds may comprise hydrates, silicate hydrates, and/or aluminosilicate hydrates.

In a preferred embodiment, the preparation is formulated as dry mortar, tile adhesive, a plaster system, a putty, a grout and/or a masonry mortar. In this regard, the preparation may contain, in addition to components (i) to (v), other auxiliaries known to the person skilled in the art.

In a further aspect, the invention also relates to the use of at least one cellulose ether selected from methylhydroxyethylhydroxypropylcellulose (MHEHPC) as additive to a formulation comprising at least one hydraulic binding agent as defined above. Typically, the cellulose ether is added to the dry components (i) and optionally (iii) and optionally (iv) by simple mixing in dry state. The formulation is preferably selected from hydraulic mortar systems, in particular cementitious mortar systems, in particular for tile adhesives, plaster systems, putties, grouts and/or masonry mortars.

The cellulose ether can be added to the at least one hydraulic binding agent at 0.05-0.6% by weight, preferably 0.1-0.5% by weight, based on the total mass of cellulose ether and hydraulic binding agent of the formulation.

Surprisingly, the preparations according to the present invention can be processed better than the systems according to the prior art. Preferably, the preparations show improved air void formation and, particularly preferably, a lower bulk density. Without being bound to a theory, the cellulose ether accumulates at the interfaces between air bubbles and the aqueous phase of the building material due to its amphiphilicity (Jenni et al. 2004), and thus promotes air entrainment into the building material.

In a further embodiment, the invention is therefore directed to a use of at least one cellulose ether selected from methylhydroxyethylhydroxypropylcellulose (MHEHPC) to reduce the bulk density of the preparation and/or improve the processability.

The present invention is illustrated by examples, but is not limited thereto:

### EXAMPLES

Composition of Tile Adhesive Mixtures:

In the following, percentages are to be understood as % by weight, unless otherwise stated or evident from the context. “atro” means “absolutely dry”.

For the production of the different tile adhesive mixtures (hereinafter referred to as FK), the following cellulose ethers (hereinafter referred to as CE) are used with the specifications as indicated below:

CE1:
Tylose MHEHPC—Methylhydroxyethylhydroxypropylcellulose
DS_{Methyl} 1.8; MS_{Hydroxyethyl} 0.4; MS_{Hydroxypropyl} 0.4
viscosity 12000-18000 mPa·s (1.9% atro, 20° C., 20° dH, Brookfield RV, spindle 5)
fine powder (air jet sieve, <0.125 mm: 95%, <0.063 mm: 50%)

CE2:
Tylose MHF 15000 P4—Methylhydroxyethylcellulose
DS_{Methyl} 1.7; MS_{Hydroxyethyl} 0.2
viscosity 11000-15000 mPa·s (1.9% atro, 20° C., 20° dH, Brookfield RV, spindle 5)
fine powder (air jet sieve, <0.125 mm: 90%, <0.100 mm: 70%)

CE 3:
Tylose MHEHPC—Methylhydroxyethylhydroxypropylcellulose (modified with polyacrylamide and starch ether)
DS_{Methyl} 1.8; MS_{Hydroxyethyl} 0.4; MS_{Hydroxypropyl} 0.4
viscosity 12000-18000 mPa·s (1.9% atro, 20° C., 20° dH, Brookfield RV, spindle 5)

CE 4:
Tylose MHF 20010 P4—Methylhydroxyethylcellulose (modified with polyacrylamide and starch ether)
DS_{Methyl} 1.7; MS_{Hydroxyethyl} 0.2
viscosity 16000-21000 mPa·s (1.9% atro, 20° C., 20° dH, Brookfield RV, spindle 5)

The cellulose ethers CE 3 and CE 4 contain small amounts of polyacrylamide and starch ether which are added by physical mixing.

The composition of the tile adhesive mixtures is shown in the following table. The indicated numbers represent parts by weight of the individual components in the tile adhesive mixture.

The water content had to be increased from 26 parts by weight to 28 parts by weight due to the additives in CE 3 and CE 4.

Test Formulations

TABLE 1
Compositions of the test mixtures (parts by weight).

| Test mixture | FK 1 | FK 2 | FK 3 | FK 4 |
|---|---|---|---|---|
| Cement CEM I 52.5N | 38 | 38 | 38 | 38 |
| Limestone powder 0.1 mm | 5 | 5 | 5 | 5 |
| Quartz sand 0.1-0.5 mm | 57 | 57 | 57 | 57 |
| Dispersion powder | | | 1 | 1 |
| CE 1 | 0.4 | | | |
| CE 2 | | 0.4 | | |
| CE 3 | | | 0.4 | |
| CE 4 | | | | 0.4 |
| water | 26 | 26 | 28 | 28 |

The following table shows the fresh mortar bulk densities of the various tile adhesive compositions.

TABLE 2
Fresh mortar bulk densities in kg/L
of the different test formulations.

| Fresh mortar bulk | | | | |
|---|---|---|---|---|
| densities as measured: | FK 1 | FK 2 | FK 3 | FK 4 |
| directly | 1.31 | 1.40 | 1.35 | 1.49 |
| after 30 min | 1.34 | 1.42 | 1.38 | 1.53 |
| after 60 min | 1.36 | 1.44 | 1.41 | 1.54 |

The fresh mortar bulk density was measured directly, after 30 min and after 60 min resting time. Table 2 clearly shows the lower fresh mortar bulk density of the test mixture with MHEHPC (FK 1) compared to the test mixture with Tylose MHF 15000 P4 (FK 2). Even after the addition of additives, MHEHPC leads to lower fresh mortar densities of the test mixture (FK 3) than Tylose MHF 20010 P4 (FK 4). This is accompanied by a very easy processability with mousse-like consistency of the tile adhesive compositions containing MHEHPC.

Test Methods for Tile Adhesives

The tile adhesives as described in Table 1 were mixed with water to form a mortar, wherein 100 parts by weight of the formulations described were mixed with 26 parts by weight of mixing water for the tests with CE 1 and CE 2 and 28 parts by weight of mixing water for the tests with CE 3 and CE 4.

First, the mixtures were stirred for 30 seconds at the lowest level, then allowed to mature for 1 minute, stirred again for 1 minute, allowed to mature for 5 minutes, and finally sheared again for 15 seconds at the lowest level. The mortar was then applied to a concrete slab using a notched trowel (according to ISO 13007). Wetting was measured by placing stoneware tiles (5×5 cm) in the mortar bed after 10, 15, 20, 25 and 30 minutes following application of the mortar (open wetting time), weighting them with 2 kg for 30 seconds and then picking them up from the mortar bed. Table 3 shows the wetting results.

TABLE 3
Wetting of the back of the tiles in % according to
DIN EN 12004 of the different test formulations.

| Wetting open time | FK 1 | FK 2 | FK 3 | FK 4 |
|---|---|---|---|---|
| after 10 min | 90 | 60 | 90 | 90 |
| after 15 min | 80 | 50 | 90 | 80 |
| after 20 min | 60 | 30 | 80 | 70 |
| after 25 min | 50 | 10 | 70 | 60 |
| after 30 min | 10 | | 60 | 40 |

The wetting degree of FK 1 or FK 3 is higher than the wetting degree of FK 2 or FK 4. MHEHPC thus leads to a slightly better wetting than MHEC.

The wetting degree of FK 1 or FK 2 is lower than the wetting degree of FK 3 or FK 4. The addition of the dispersion powder and the additives thus leads to an improvement in wetting.

The adhesive strength after a specific open time for tile adhesives is determined according to DIN EN 12004 by applying the tile adhesive to a defined concrete slab (here Solana) by means of a notched trowel. After 10, 20 and 30 minutes open time after application of the mortar, 4-8 stoneware tiles per time unit are placed in the mortar bed and weighted down with a 2 kg weight for 30 seconds. The stoneware tiles are then stored for 28 days in a standard climate (23° C. and 50% humidity). After storage, the tensile adhesive strength values are determined by tearing the tiles from the concrete slab using a tensile bond strength tester (Herion). The determined values are listed in Table 4.

The adhesive strength for different storage types according to DIN EN 12004 was also determined. The values listed in Table 4 represent the adhesive tensile strength values after dry storage or standard storage (28 days at 23° C. and 50% humidity), warm storage (14 days standard climate, 14 days at 70° C.) and water immersion (1 week standard climate, three weeks in standard temperature water).

TABLE 4
Adhesion strengths in N/mm² according to DIN
EN 12004 of the different test formulations.

| | | | |
|---|---|---|---|
| FK 1 | FK 2 | FK 3 | FK 4 |

Open time according to ISO 12004

| | | | | |
|---|---|---|---|---|
| 10 min | 0.96 | 0.81 | 0.90 | 1.16 |
| 20 min | 0.51 | 0.51 | 0.97 | 0.94 |
| 30 min | 0.17 | 0.26 | 0.79 | 0.53 |

Storage types according to DIN EN 12004

| | | | | |
|---|---|---|---|---|
| Standard | 1.29 | 1.03 | 0.68 | 0.66 |
| Water | 1.05 | 1.19 | 1.00 | 0.79 |
| Warm | 1.05 | 0.94 | 0.56 | 0.53 |
| Frost/dew | 1.45 | 1.54 | 0.85 | 0.61 |

The adhesive strengths of the test mixtures FK 1 and FK 2 in relation to the open time are comparable, taking into account the fault tolerance of ±0.2 N/mm². The use of CE 1 (MHEHPC) and CE 2 (MHEC) in the test mixtures therefore leads to comparable adhesive strengths. Due to the addition of dispersion powder and additives, the adhesive strengths are higher overall in relation to the open time. FK 3 (MHEHPC) even exceeds the adhesive strength of FK 4 (MHEC) after 30 minutes open time.

With regard to the different storage types, there are again no significant differences in adhesive strength for FK 1 and FK 2 when the fault tolerance of ±0.2 N/mm² is taken into account. The same applies after addition of the dispersion powder and the additives for FK 3 and FK 4, whereby higher overall adhesive strengths are achieved for the test compound with MHEHPC even when taking the fault tolerance into account.

Conclusion:

By using MHEHPC, the raw mortar density can be reduced and therefore a light and mousse-like consistency can be achieved, which facilitates the processing of hydraulically setting building materials. This is all the more remarkable as the adhesive strength values are comparable to those described in the prior art.

The following items are comprised by the present invention:

1. Preparation comprising.

(i) at least one hydraulic binding agent,

(ii) at least one cellulose ether selected from methylhydroxyethylhydroxypropylcellulose (MHEHPC),

(iii) optionally at least one filler,

(iv) optionally at least one additive, and

(v) optionally water.

2. Preparation according to item 1, wherein the hydraulic binding agent is selected from cement and hydraulic lime, preferably cement.

3. Preparation according to item 2, wherein the cement is selected from the group consisting of CEM I, CEM II/A-S, CEM II/B-S, CEM II/A-D, CEM II/A-P, CEM II/B-P, CEM II/A-Q, CEM II/B-Q, CEM II/A-V, CEM II/B-V, CEM II/A-W, CEM II/B-W, CEM II/A-T, CEM II/B-T, CEM II/A-L, CEM II/B-L, CEM II/A-LL, CEM II/B-LL, CEM II/A-M, CEM II/B-M, CEM III/A, CEM III/B, CEM III/C, CEM IV/A, CEM IV/B, CEM V/A and/or CEM V/B.

4. Preparation according to item 3, wherein the cement has a strength class according to DIN EN 197-1 of 32.5, 42.5 or 52.5.

5. Preparation according to item 3 or 4, wherein the cement has an initial strength according to DIN EN 197-1 of N, R or L.

6. Preparation according to item 2, wherein the hydraulic lime comprises CaO.

7. Preparation according to any one of items 1-7, wherein the at least one cellulose ether selected from methylhydroxyethylhydroxypropylcellulose (MHEHPC) has an average degree of substitution DS_{Methyl} of 1.2-2.35, preferably 1.5-2.25, particularly preferably 1.7-2.15, most preferably 1.75-2.0.

8. Preparation according to any one of items 1-7, wherein the at least one cellulose ether selected from methylhydroxyethylhydroxypropylcellulose (MHEHPC) has a molecular degree of substitution MS_{Hydroxyethyl} of 0.1-0.99, preferably 0.15-0.8, more preferably 0.25-0.6, most preferably 0.2-0.5.

9. Preparation according to any one of items 1-8, wherein the at least one cellulose ether selected from methylhydroxyethylhydroxypropylcellulose (MHEHPC) has a molecular degree of substitution MS_{Hydroxypropyl} of 0.1 to 0.99, preferably 0.15 to 0.8, particularly preferably 0.25-0.6, most preferably 0.3-0.5.

10. Preparation according to any one of items 1-10, wherein the at least one cellulose ether selected from methylhydroxyethylhydroxypropylcellulose (MHEHPC) has an average degree of substitution DS_{Methyl} of 1.2-2.35, preferably 1.5-2.25, particularly preferably 1.7-2.15, most preferably 1.75-2.0, has a molecular degree of substitution MS_{Hydroxyethyl} of 0.1 to 0.99, preferably 0.15 to 0.8, particularly preferably 0.25-0.6, most preferably 0.2-0.5, and has a molecular degree of substitution MS_{Hydroxypropyl} of 0.1 to 0.99, preferably 0.15 to 0.8, particularly preferably 0.25-0.6, most preferably 0.3-0.5.

11. Preparation according to any one of the preceding items, wherein the at least one cellulose ether selected from methylhydroxyethylhydroxypropylcellulose (MHEHPC) has a weight average degree of polymerization (DPw) of 1 to 6000, preferably 1 to 5000, measured according to ISO 5351:2010.

12. Preparation according to any one of the preceding items, wherein the at least one cellulose ether selected from methylhydroxyethylhydroxypropylcellulose (MHEHPC) has a water solubility of at least 2 g/L water at 20° C.

13. Preparation according to any one of the preceding items, wherein component (ii) has a viscosity of 1 to 70,000 mPa·s, preferably 100 to 15,000 mPa·s, more preferably 1000 to 12,000 mPa·s (according to DIN 53015:2019-06; measured in an aqueous solution containing 1.9% by weight of component (ii) based on the total weight of the solution at 20° C. and 20° dH).

14. Preparation according to any one of the preceding items, wherein the proportion of component (ii) is 0.05-0.6% by weight, preferably 0.1-0.5% by weight, most preferably 0.3-0.4% by weight, based on the total mass of components (i) and (ii).

15. Preparation according to any one of the preceding items, wherein the at least one filler is selected from gravel, quartz sand, limestone powder and/or synthetic fillers.

16. Preparation according to any one of the preceding items, wherein the at least one filler has an average particle size d₅₀ of 0-3 mm.

17. Preparation according to any one of the preceding items, wherein the proportion of component (iii) is 5-85% by weight, preferably 35-70% by weight, based on the total weight of components (i), (ii), (iii) and optionally (iv).

18. Preparation according to any one of the preceding items, wherein the at least one additive is selected from dispersion powder, inorganic thickener, hardening accelerator, setting retarder, polymer, defoaming agent, air entraining agent, flow agent, hydrophobizing agent and/or fibers.

19. Preparation according to any one of the preceding items, wherein the proportion of component (iv) is 0-12% by weight, preferably 1-5% by weight, based on the total mass of components (i), (ii), (iv).

20. Preparation according to any one of the preceding items, wherein the proportion of component (v) is 18-32% by weight, preferably 22-28% by weight, based on the total mass of components (i) and (v).

21. Preparation according to any one of the preceding items, wherein the preparation is a dry mortar, tile adhesive, plaster system, a putty, grout and/or masonry mortar.

22. Use of at least one cellulose ether selected from methylhydroxyethylhydroxypropylcellulose (MHEHPC) as an additive to a formulation comprising at least one hydraulic binding agent.

23. Use according to item 22, wherein the formulation is selected from hydraulic mortar systems, in particular cementitious mortar systems, in particular for tile adhesives, plaster systems, putties, grouts and/or masonry mortars.

24. Use according to any one of items 22 or 23 for reducing the bulk density of the formulation and/or improving the processability.

1. Preparation comprising
(i) at least one hydraulic binding agent,
(ii) at least one cellulose ether selected from methylhydroxyethylhydroxypropylcellulose (MHEHPC),
(iii) optionally at least one filler,
(iv) optionally at least one additive, and
(v) optionally water.

2. Preparation according to claim 1, wherein the hydraulic binding agent is selected from cement and hydraulic lime, e.g. CaO, preferably cement.

3. Preparation according to claim 1, wherein the methylhydroxyethylhydroxypropylcellulose (MHEHPC) has an average degree of substitution DS_{Methyl} of 1.2-2.35, preferably 1.5-2.25, particularly preferably 1.7-2.15, very particularly preferably 1.75-2.0; and/or
wherein the at least one cellulose ether selected from methylhydroxyethylhydroxypropylcellulose (MHEHPC) has a molecular degree of substitution MS_{Hydroxyethyl} of 0.1 to 0.99, preferably 0.15 to 0.8, particularly preferably 0.25-0.6, most preferably 0.2-0.5; and/or
wherein the at least one cellulose ether selected from methylhydroxyethylhydroxypropylcellulose (MHEHPC) has a molecular degree of substitution MS_{Hydroxypropyl} of 0.1 to 0.99, preferably 0.15 to 0.8, particularly preferably 0.25-0.6, most preferably 0.3-0.5.

4. Preparation according to claim 1, wherein the at least one cellulose ether selected from methylhydroxyethylhydroxypropylcellulose (MHEHPC) has an average degree of substitution DS_{Methyl} of 1.2-2.35, preferably 1.5-2.25, particularly preferably 1.7-2.15, most preferably 1.75-2.0, has a molecular degree of substitution MS_{Hydroxyethyl} of 0.1 to 0.99, preferably 0.15 to 0.8, particularly preferably 0.25-0.6, most preferably 0.3-0.5.

5. Preparation according to claim 1, wherein the at least one cellulose ether selected from methylhydroxyethylhydroxypropylcellulose (MHEHPC) has a water solubility of at least 2 g/L water at 20° C.

6. Preparation according to claim 1, wherein the proportion of component (ii) is 0.05-0.6% by weight, preferably 0.1-0.5% by weight, most preferably 0.3-0.4% by weight, based on the total mass of components (i) and (ii).

7. Preparation according to claim 1, wherein the at least one filler is selected from gravel, quartz sand, limestone powder and/or synthetic fillers.

8. Preparation according to claim 1, wherein the proportion of component (iii) is preferably 35-70% by weight based on the total weight of components (i), (ii), (iii) and optionally (iv).

9. Preparation according to claim 1, wherein the at least one additive is selected from dispersion powder, inorganic thickener, hardening accelerator, setting retarder, polymer, defoaming agent, air entraining agent, flow agent, hydrophobizing agent and/or fibers.

10. Preparation according to claim 1, wherein the proportion of component (iv) is preferably 1-5% by weight based on the total mass of components (i), (ii), (iv) and optionally (iii).

11. Preparation according to claim 1, wherein the proportion of component (v) is 18-32% by weight, preferably 22-28% by weight, based on the total mass of components (i) and (v).

12. Preparation according to claim 1, wherein the preparation is a dry mortar, tile adhesive, plaster system, a putty, grout and/or masonry mortar.

13. A formulation comprising at least one binding agent and at least one cellulose ether selected from methylhydroxyethylhydroxypropylcellulose (MHEHPC).

14. The formulation according to claim 13, where the binding agent comprises a hydraulic binding agent and the formulation is a hydraulic mortar system.

15. A method for reducing the bulk density and/or improving the processability of a formulation comprising adding at least one cellulose ether selected from methylhydroxyethylhydroxypropylcellulose (MHEHPC) to the formulation.

16. The formulation according to claim 13, wherein the formulation comprises a cementitious mortar system, a tile adhesive, a plaster system, a putty, a grout, or a masonry mortar.
